(19) United States
(12) Patent Application Publication
(10) Pub. No.: US 2013/0176403 A1
(43) Pub. Date: Jul. 11, 2013

(54) Heads up display (HUD) sensor system

(71) Applicant: Kenneth Varga, Peoria, AZ (US)

(72) Inventor: Kenneth Varga, Peoria, AZ (US)

(21) Appl. No.: 13/385,038

(22) Filed: Jan. 30, 2012

Related U.S. Application Data
(60) Provisional application No. 61/575,131, filed on Aug. 16, 2011.

(51) Int. Cl. H04N 13/02

(52) U.S. Cl. CPC H04N 13/0242
USPC 348/48

(57) ABSTRACT

An omnidirectional stereoscopic camera and microphone system consisting of one or more left and right eye camera and microphone pairs positioned relative to each other such that omnidirectional play back or a live feed of video and omni-directional acoustic depth perception can be achieved. A user or users can select a direction of gaze as well as to hear, and share the experience visually and audibly with the system as if the user or users are physically present. The sensor system orientation is tracked and known by compass and/or other orientation sensors enabling users to maintain gaze direction, independent of sensor system orientation changes.

### CROSS-REFERENCE TO RELATED APPLICATIONS

This application claims benefit of the Aug. 16, 2011 filing date of Provisional Patent Application No. 61/575,131 pursuant to 35 U.S.C. sec 119. Related applications: 20100240988, 20100238161

### FEDERALLY SPONSORED RESEARCH

None.

### SEQUENCE LISTING

None.

### FIELD OF THE INVENTION

This invention relates to three dimensional (3D) omni-directional stereoscopic immersion and/or telepresence systems and methods where recording and/or playback and/or live play of video/image and/or audio experiences from one or more locations can be achieved.

### BACKGROUND OF THE INVENTION

This invention places emphasis on using camera systems as well as audio systems to capture omni-directional depth data, to capture and produce live-feed or playback of remote reality. There are many techniques in the prior art for capturing three dimensional (environment) data from various types of sensors from depth cameras (RGB-D: red, green, blue, depth via time of flight or structured light with stereo), laser sensor systems, radar, active and passive acoustic systems, as well as from camera images. Prior art also includes using one or more panoramic omni-directional cameras using mirrors, as well as arrays of multiple cameras that point in different directions, as well as arrays of multiple microphone arrays for recording/capturing of sound in different directions.

### Prior Omni-Directional Camera Systems

At the time of this invention, perhaps the most well known omni-directional camera system is Google's Street View camera, as described in the article “Google Street View”, Wikipedia, Oct. 14, 2011, Wikimedia Foundation. Another panoramic camera system is described in Throwable 36-camera ball takes perfect panorama photos, Oct. 14, 2011, Anthony, S., Extreme Tech. Other integrated camera and display systems have been developed where users can experience more than just a flat screen view of a panoramic video by having surrounding displays or using a head mounted display, see Internet Telepresence by Real-Time View-Dependent Image Generation with Omnidirectional Video Camera, Morita S. et. al., Nara Institute of Science and Technology, Japan; Panoramic Movie Generation Using an Omnidirectional Multi-camera System for Telepresence, Ikeda, S. et. al., Nara Institute of Science and Technology, Nara, Japan; Immersive Telepresence System Using High-resolution Omnidirectional Video with Locomotion Interface, Ikeda, S. et. al., Nara Institute of Science and Technology, Japan; How Elumens Vision Station Works, Tyson, J., Discovery, Atlanta, Ga., USA; all of which enhance viewing of the omni or semi omni-directional video. Other similar systems are shown in U.S. Pat. Nos. 6,375,366; 6,005,984; U.S. Pat. App. 2010/0299630. None of these systems, including Google's Street View camera system, are presently known to incorporate depth data or omni-directional microphones as well as camera orientation sensors.

Other omni-directional camera systems do exist in the prior art that do incorporate microphones such as Visisonic's “RealSpace™ Panoramic Audio Camera” product. Although these systems provide omni-directional camera views and/or omni-directional microphones, they do not provide stereoscopic depth perception.

### Prior Omni-Directional Stereoscopic Camera Systems

Stereoscopic camera systems are very well known in the prior art, and there are many omni-directional stereoscopic camera systems in the prior art. Omni-directional and/or panoramic stereoscopic system are described in U.S. Pat. Nos. 8,004,558; 7,982,777; 7,877,007; 7,872,665; 7,656,403; 7,463,280; 7,429,997; 7,397,504; 7,224,382; 7,176,960; 7,015,954; 6,831,677; 6,795,109; 6,734,914; 6,665,003; 6,333,826; 6,141,034; 5,721,585; and the paper Real-Time Omnidirectional and Panoramic Stereo, Gluckman, J., et. al., Columbia University, New York, N.Y. In this research two panoramic cameras using hyperbolic mirrors are used to achieve image depth data. Other such systems are described in Omnidirectional Vision Systems: 1998 PI Report, Nayar, S., et. al., Columbia University, New York, N.Y.; MIT develops a 360-degree stereoscopic 3D motion picture camera system, Keyser, H., Sep. 22, 2011, Telepresence Industry Professionals. A multiple view stereoscopic camera system is described in Stereo Omnidirectional System Intelligent Wheelchair, Sep. 21, 2006, Christensen, B., “Science Fiction In the News: The predictions of science fiction writers coming true in today's world,” where an omnidirectional view is created by multiple cameras. Other analysis of 3D reconstruction from multiple cameras of different views is described in A Comparison and Evaluation of Multi-View Stereo Reconstruction Algorithms, Seitz, S., et. al., University of Washington, as well as in Surface Reconstruction from Multi-View Stereo, Salman, N., et. al., INRIA Sophia Antipolis, France; Symmetric Multi-View Stereo Reconstruction From Planar Camera Arrays, Maitre, M., Micrsoft, Redmond, Wash.; Virtually There: Three-dimensional tele-immersion may eventually bring the world to your desk, Lanier, J., Scientific American, April, 2001, pgs. 66-75; Remote Reality for Immersive Communications and Games, Do, M, et. al., 2011, University of Illinois at Urbana-Champaign, Research and Education in Singapore; U.S. Pat. App. No. 2005/0185711.

An efficient method of achieving depth data with omnidirectional stereoscopic imaging using just a single camera with a lens and a mirror is described in A Novel Omnidirectional Stereo Vision System with a Camera, Yi S., et. al., ICIAR 2006, Seoul National University of Technology, Republic of Korea, as well as in Omnistereo: Panoramic Stereo Imaging, Peleg, S. et. al., IEEE Transactions on Pattern Analysis and Machine Intelligence, VOL. 23, NO. 3, March 2001.

Red, Green, Blue, and Depth (RGB-D) camera systems have been developed as described in TRAVIS DEYLE, “Low-Cost Depth Cameras (aka Ranging Cameras or RGB-D Cameras) to Emerge in 2010?”, Hizook, Mar. 29, 2010, Atlanta, Ga. and WIKIPEDIA, “Time-of-flight camera”, Wikimedia Foundation Inc., Nov. 14, 2011, San Francisco, Calif. where a camera is combined with time of flight or structured light with stereo to achieve depth data, but we are unaware if any of these RGB-D type camera systems are known to be combined with an omni-directional camera system.

### Prior Multi-Channel Audio/Sound Recording Systems

Sound recording is just one aspect of the invention where multi-microphone systems are well known. Examples of multi-channel omnidirectional audio recording systems are in U.S. Pat. Nos. 7,881,479; 7,852,369; 7,224,385; 6,851,512; 4,984,087; 4,334,740; RE38,350; U.S. Pat. App. 2010/0260483, 2006/0227224; where multiple microphones are used at different angles to record sound and produce a surround sound or highly directionally correlated sound recording where a sound experience can be reproduced.

### Prior Video/Image Recording Camera, Multi-Channel Audio Recording, & Playback Systems

A prior panoramic/omni directional audio and video camera system is described in the article VisiSonics to launch panoramic A/V camera at AES, Sep. 26, 2011; Keyser, H.; Telepresence Industry Professionals; as well as in U.S. Pat. Nos. 5,495,576; 5,130,794; U.S. Pat. App. 2003/0103744, and 2004/0001137.

At the time of this invention, we are not aware of any existing systems as well as none of the mentioned prior art systems provide both stereoscopic vision combined with stereoscopic sound in such a way as to correlate with the orientation with the users eye and ear positions, such that an experience can be more fully shared.

### OBJECTS OF THE INVENTION

This application relates to a stereoscopic multi-angle camera system allowing a user to take pictures and/or video and record stereoscopic sound not only as a spherical view but also using stereoscopic imaging/recording by having two cameras and two microphones per solid angle of view such that omnidirectional visual and omnidirectional acoustic depth perception is achieved.

The stereoscopic cameras and microphones can be wide angle cameras and microphones positioned such that every direction or any set of directions can be captured in a single image frame and sound recording group while simultaneously giving depth perception with spherical stereoscopic perspective view and hearing capability. The picture(s), video(s), sounds can be viewed and heard on the sensor system itself or by transferring them using a memory card, thumb drive, wirelessly, or by cable to another device.

For viewing the images external to the camera and sound recording system, a Heads Up Display (HUD) or other display and sound device can be used that detects the orientation of the user's head, eyes, zoom level, and/or other orientation control device position selected and calibrated to the image and/or video angles and incorporating depth perception through stereoscopic projection onto the user's eyes. This can be done with orientation and rotational sensors as well as translational or other sensors correlated with known camera and microphone angles in the recorded or live data. Another method to view the images and/or video is using 3D (three dimensional) glasses with a monitor. A plain monitor or television can be used to view the images and/or video while using cursor keys, mouse, joystick, or other controlling mechanism to adjust the view in 3D.

The stereoscopic sound is captured with the spherical sensor system such that sound sources are also captured directionally and stereoscopically and correlate with the 3D spherical imaging. This is achieved by having an omnidirectional microphone or microphones oriented such that the sound captured is tagged relative to image data such that when played it is as if a person's head and ears were physically at the origin of the spherical camera facing in a specific gaze direction. Multiple microphones can be used such that every solid angle or a set of solid angles are covered, such that head orientation can be replicated with ears corresponding to direction relative to head orientation. This can be achieved by orienting a microphone at about +90 degrees and a microphone at about −90 degrees from the camera head gaze direction or a nearer equivalent to replicate acoustic characteristics of human ears with respect to human head gaze direction, thus achieving the approximate position of the human ears with respect to the human head gaze.

For hearing the sounds, a speaker or speakers, headphones, or a surround sound speaker system can be correlated with the orientation data with the listener, such as by head & eye orientation sensors, cursor, joystick, or other angular feedback control mechanism. The sounds can be heard stereoscopically as if the person's ears were at the origin of the spherical camera system about +/−90 degrees off the head gaze direction effectively emulating orientation of ears. This system enables a user to remotely detect (or program to calculate) the origin of a sound source through computation or by allowing detection of the movement of the user'(s) head orientation.

A further embodiment for the playback can be a stereoscopic spherical (or hemispherical) display theatre with a display floor, walls, and ceiling where all the 3D stereoscopic images are projected or displayed onto the sphere (or hemisphere) along with sounds presented spherically (or hemi-spherically).

### SUMMARY

An improved camera and audio recording, playback, and live feed sensor system that incorporates an ability to simultaneously capture spherical stereoscopic images and/or videos and/or spherical stereoscopic sound as well as display and play stereoscopically at a select angle and/or zoom level or from all (or a set of) directions simultaneously or in rapid sequence. The sensor system allows immersion of a remote environment, as well as detailed environmental image and sound data geometry.

### DRAWINGS

FIG. 1A is an example of a planar view of the sensor system showing a planar slice.

FIG. 1B is an example of a perspective view of the sensor system.

FIG. 2 is a block diagram of the sensor system showing major component details interfacing with an experience sharing and controlling system.

FIG. 3 is a block diagram of the experience sharing and controlling system showing major component details interfacing with a user whereby the user is able to select, control, display, zoom, and/or see, and hear the data in a desired gaze direction in real time or as play back.

FIG. 4 is a general process flow chart that allows for the displaying, speaking, and controlling of the data.

### DETAILED DESCRIPTION

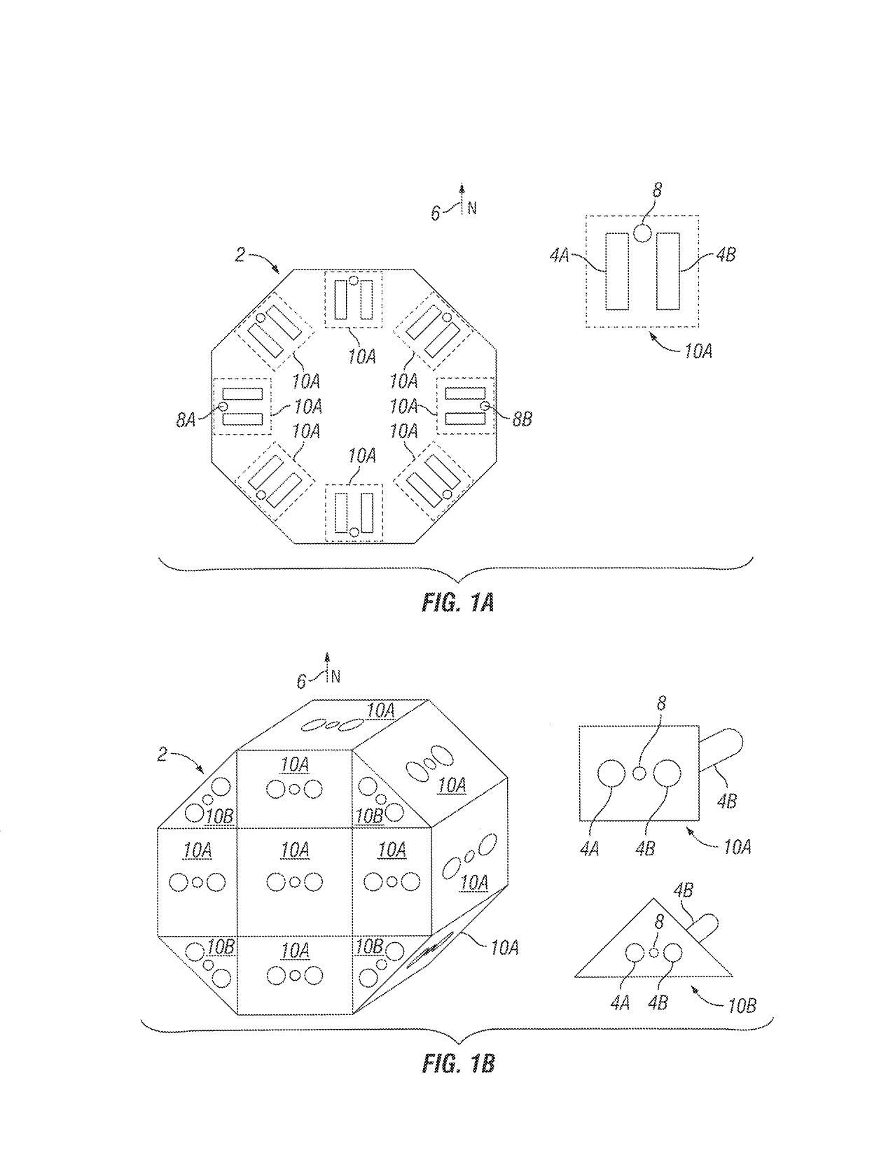

FIG. 1A is an example planar slice of a sensor system 2 looking down from above, and a perspective view of the sensor system FIG. 1B with reference orientation to north 6 shown. Left eye camera 4A, right eye camera 4B, are shown as a pair with microphone 8 as one square face module 10A and one triangular face module 10B. For the sensor system 2 shown in FIG. 1B, there are twenty-six surfaces containing square face 10A, and triangular face 10B modules each having two cameras 4, one for the left eye 4A, and one for the right eye 4B, and a microphone 8 used to interpolate spherical directionally dependent data so that it is corresponding to the relative eye and ear orientation of a user's head gaze direction. The cameras 4 (4A and 4B) can be made gimbaled and zoom-able via electronic controls, and can also contain a combination of a zoom-able camera as well as a fish eye lens camera, or be a catadioptric mirror camera or other suitable camera system such as infrared or ultraviolet or any combination. There can be any number of cameras, microphones and surfaces limited to the geometry of the cameras 4 and microphones 8 and supporting structure. For clarity, power and data lines are not shown in the figures. If occlusion occurs on any mounting surface, external camera(s) 4 and microphone(s) 8 can be optionally placed on the opposite end of the mounting surface or elsewhere (thus no longer occluded) and integrated into the sensor system 2. The sensor system 2 can be mounted anywhere, and can be incorporated into a helmet, and/or the sensor system 2 can be combined and integrated into the experience sharing system 26 as a Heads Up Display (HUD). Other camera types 4 can be used, and the invention is not limited to the geometry or camera type. For instance, a single omnidirectional mirror lens camera can be used in place of multiple cameras. The cameras are not limited to be just visible cameras, they can be infrared, ultra-violet, or other, or any combination. Data from multiple cameras and camera types can be combined and/or aligned and/or overlaid to enhance the understanding and utility of the data.

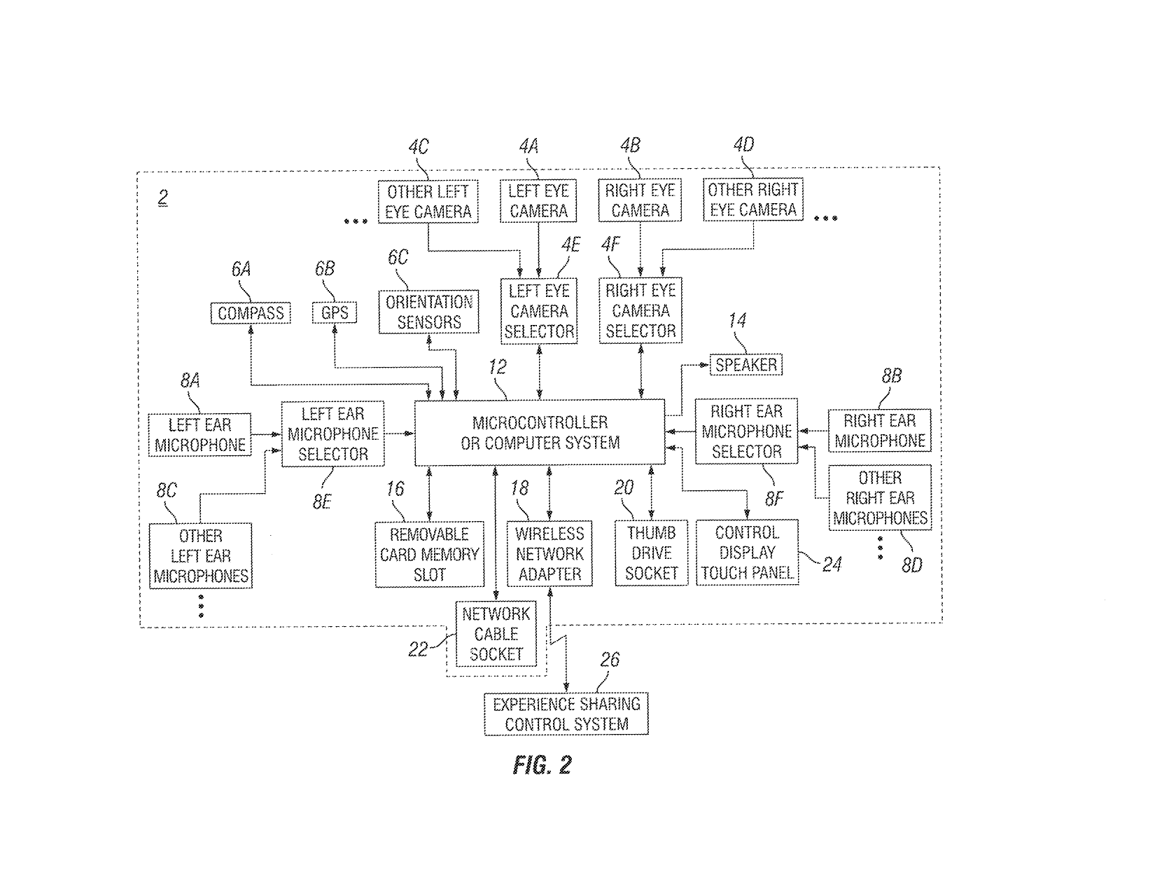

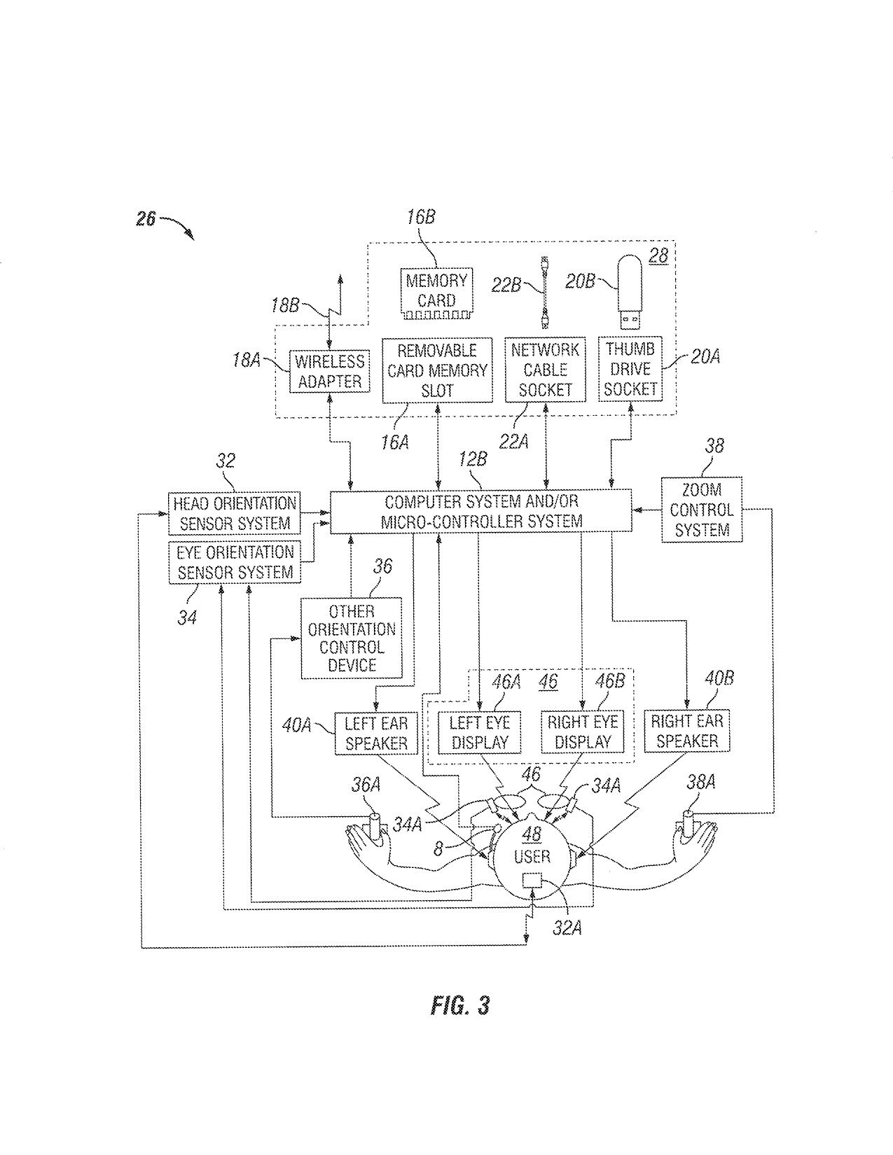

FIG. 2 is a block diagram of the sensor system 2 connected to experience (perceptual) sharing and controlling system 26 with the major block components for the sensor system 2 shown. Compass 6A, Global Positioning System (GPS) or equivalent 6B, orientation sensors 6C are shown connected to micro-controller or computer system 12. The orientation sensors can be inertial reference, contain accelerometers, or laser gyroscopic sensor or other type of orientation sensor system to acquire sensor system orientation 2. The orientation sensors 6C can be expanded to include other sensor types for different uses to improve experience capturing, such as humidity sensors, wind speed and direction sensors, pressure sensors, mass spectrometer sensors to capture smell, or other sensors of any type to help with capturing and reproducing the immersion experience. The experience sharing and controlling system 26 is similar to a tele-presence or remote immersion system that allows a remote user or users to experience another location or play back an experience. The computer 12 can be a microcontroller and/or computer system that integrates routes, and controls data and power with the other system components shown. Left eye camera 4A or other left eye cameras 4C are selected by left eye camera selector 4E or are simultaneously routed to computer 12. Right eye camera 4B or other right eye cameras 4D are selected by right eye camera selector 4F or are simultaneously routed to computer 12. Left ear microphone 8A and other left ear microphones 8C are selected through left ear microphone selector 8E or are simultaneously routed to computer 12. Right ear microphone 8B and other right ear microphones 8D are selected through right ear microphone selector 8F or are simultaneously routed to computer 12. Having positioned left and right ear microphones and camera eyes allows a user to experience visual and acoustic depth perception of a remote environment at all angles of head and eye orientation. Data is transferred to experience sharing and controlling system 26 through removable card memory slot 16 and memory card (16B of FIG. 3) network cable socket 22, wireless (WiFi, Bluetooth, Infrared-IR, or other suitable wireless technology) network adapter 18 via wireless signal (18B of FIG. 3), and/or thumb drive socket 20. Alternatively, the experience can be recreated on the remote sensor system 2 itself via a control touch panel (or other) playback system 24 and speaker(s) 14 that can be projected from the sensor system 2 controlled by image or other sensor sensing techniques as well as through voice command through any microphone 8 or just be an ordinary touch screen display on a edge with space available, or internally where the sensor system opens up using a hinge (not shown in the figure) with an internal control display touch panel 24.

FIG. 3 is a block diagram of the major components of the remote experience sharing and controlling system 26 of which can be duplicated in desired portions as control and display touch panel (or other interface) playback system 24 and speaker(s) 14 of FIG. 2 or by other means. Computer system and/or microcontroller system 12B controls, routes, and integrates data and power between devices within the remote experience sharing and controlling system 26 and user 48 as well as to and/or from sensor system 2 of FIG. 1A, FIG. 1B, and FIG. 2. The remote experience sharing and controlling system 26 is connected to any one or multiple methods via wireless adapter 18A through wireless signal 18B, as well as through removable card memory slot 16A and memory card 16B, as well as through network cable socket 22A, network cable 22B, thumb drive (can be a Universal Serial Bus—USB or other bus) socket 20A and thumb drive 20B. User 48 control and feedback is established through head 32 and eye 34 orientation sensor systems connected to user 48, head sensor 32A, eye sensors 34A, other orientation control device 36 to other human machine interface device 36A, as well as zoom control system 38 through zoom control human machine interface device 38A, all as a method to interface to computer system 12B. Head orientation 32 and eye tracking 34 sensor systems as well as display glasses 46 do not have to be mounted on user 48 as they can be remote sensing and/or displaying systems as well. Combination stereoscopic display 46 can be one or more displays, such as a left eye display 46A, and right eye display 46B, and/or utilize polarized or colored glasses 46. Stereoscopic sound is presented to the user through left ear speaker 40A, and right ear speaker 40B from computer system 12B with appropriate amplification and digital to analog conversion inside computer system 12B. User 48 speech recognition control can be accomplished through microphone 8 connected to computer system 12B with appropriate amplification and analog to digital conversion inside computer system 12B.

Speakers 40A and 40B can be earphones where sound can be reproduced based on head orientation, thus requiring only one speaker per ear, but still generating surround sound and still further, headphones can be such that they generate surround sound internally by having multiple directions of sound source per ear (multiple speakers producing multiple acoustic bearings per ear or having the net effect of) or the two external speakers can stereoscopically generate the variance required based on the head orientation (using two or more speakers) by use of time delay between speaker headsets. Objects manipulated in computer space can be moved towards the user's head and the sound can be adjusted in 3D, amplified and directed based on objects orientation and distance between user's head. As an example, a user can pick up a virtual seashell and move it close to their ear and hear the sound of a seashell, or a recording or a live play of the same location on the sensor system 2 can be remotely experienced.

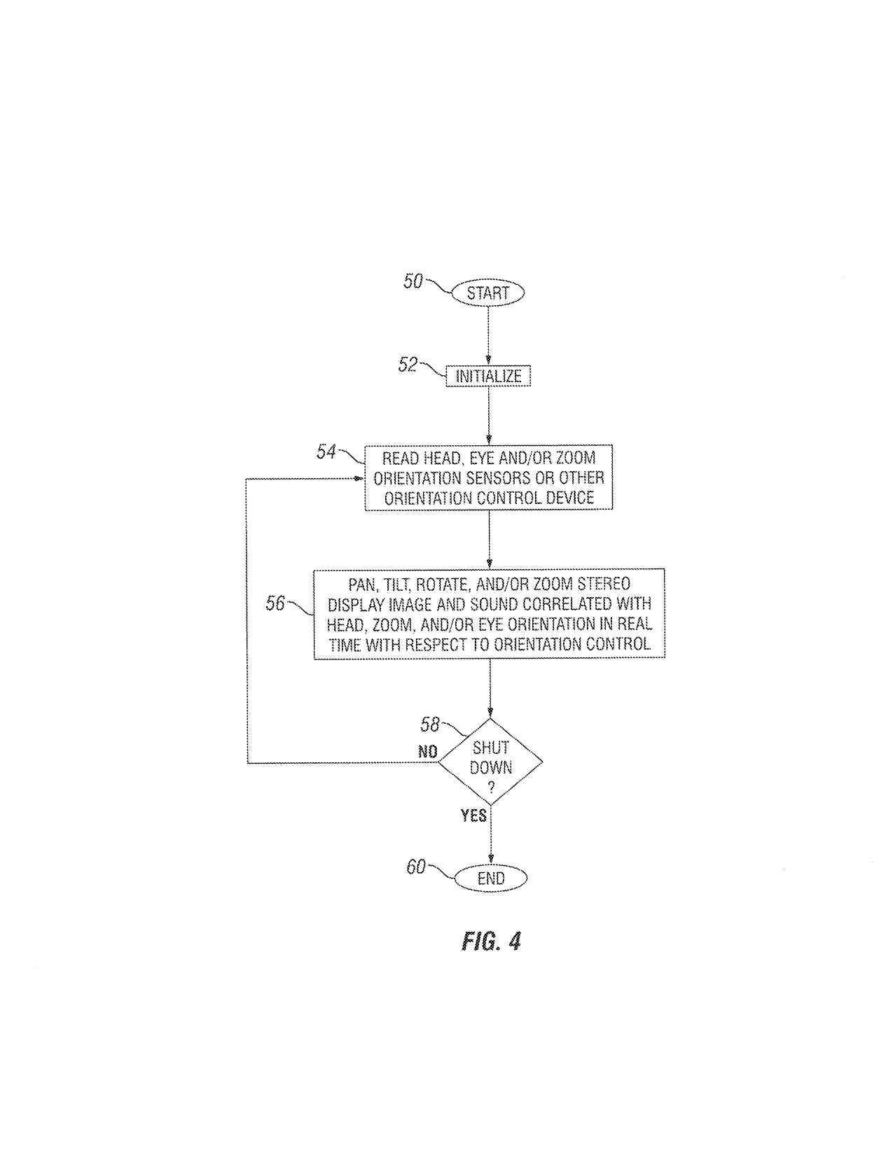

FIG. 4 is a general flow chart of the main system process for the microcontroller and/or computer system 12 and/or 12B where the process starts at 50 and initializes at process block 52 where the head, eye, zoom or other orientation sensor devices are read at process block 54, and then the process pans, tilts, rotates, and/or zooms the stereoscopic display image and sound correlated with head, zoom, and/or eye orientation in real time with respect to the orientation control at process block 56, whereby if the system shuts down at decision block 58, the process ends at 60 or continues back to reading the head, eye, zoom or other orientation sensor devices 54. If display system is a spherical (or hemispherical) theatre system, then process steps 54 and 56 may not be necessary.

### REFERENCE NUMERALS

2 sensor system
4 camera(s)
4A left eye camera
4B right eye camera
4C other left eye cameras
4D other right eye cameras
4E left eye camera selector
4F right eye camera selector
6 reference direction north
6A compass
6B GPS
6C orientation sensors
8 microphone
8A left ear microphone
8B right ear microphone
8C other left ear microphones
8D other right ear microphones
8E left ear microphone selector
8F right ear microphone selector
10A left & right eye camera pair with microphone square face module
10B left & right eye camera pair with microphone triangular face module
12 microcontroller and/or computer system
12B microcontroller or computer system on experience sharing and controlling system
14 speaker(s)
16 removable card memory slot
16A removable card slot on experience sharing and controlling system
16B removable memory card
18 wireless network adapter
18A wireless adapter on experience sharing and controlling system
18B wireless signal
20 thumb drive socket
20A thumb drive socket on experience sharing and controlling system
20B thumb drive
22 network cable socket
22A network cable socket on experience sharing and controlling system
22B network cable
24 control display touch panel
26 remote experience sharing and controlling system
32 head orientation sensor system
32A head orientation sensor(s)
34 eye orientation sensor system
34A eye orientation sensor(s)
36 other orientation control device
36A other orientation control human machine interface device
38 zoom control system
38A zoom control human machine interface device
40A left ear speaker, can be part of a spherical theatre
40B right ear speaker, can be part of a spherical theatre
46 combined stereoscopic three dimensional depth perception display and/or glasses, can have touch screen capability, can be spherical theatre
46A left eye display
46B right eye display
48 user
50 process start
52 initialize process block
54 read head, eye, and/or zoom orientation sensors, or other orientation control device process block
56 pan, tilt, rotate, and/or zoom stereo display image and stereo sound correlated with head and/or eye orientation in real time with respect to orientation control process block
58 shut down condition block
60 process end

### Operation

The sensor sound system operates by a user or program activating the recording, play, or live mode, where the cameras and microphones are activated for recording, playing, or sending live video and sound.

Viewing and hearing of the video, pictures, and/or sounds is achieved either within the sensor system device itself or through another device by either transferring the data wirelessly, through a cable, or through a removable memory card or thumb drive. The data can be viewed or heard by a user or program selecting different angles of view, or the data can be heard or viewed by a user enveloped in an environment where all the spherical video, image, and sound data are presented and displayed simultaneously or selectively. The user can select and zoom in and out of a view to see and hear by manually moving cursor keys, joystick, mouse, or other control device, or by speech recognition command, or by orientation tracking sensors on the users head and sensors for tracking eyes. Multiple users can experience the data from the sensor system simultaneously. An application of this can be a person in the field can be assisted by having others look in other directions and assist the user with the sensor system locally of events and conditions taking place outside the local user's gaze that the user is not focusing on.

I claim:

1. A camera and audio system comprising a plurality of cameras and a platform, said plurality of cameras mounted on said platform such that at least one of said plurality of cameras views each possible direction, and at least one microphone.
